(19) United States
(12) Patent Application Publication
(10) Pub. No.: US 2021/0190383 A1
(43) Pub. Date: Jun. 24, 2021

(54) SELECTIVE SURFACES FOR RADIANT HEAT TRANSFER

(71) Applicant: Will John Temple, Placerville, CA (US)

(72) Inventor: Will John Temple, Placerville, CA (US)

(21) Appl. No.: 16/726,742

(22) Filed: Dec. 24, 2019

(51) Int. Cl. F24S 23/70

(52) U.S. Cl. CPC F24S 23/70

(57) ABSTRACT

The present invention relates to a heat transfer device or system for the use of moving heat energy, which is generally cooling or heating. The device or system comprising at least one selective surface (1), wherein the selective surface comprises at least one radiant concentrator or lens (5) and at least one conductive material (4) comprising at least one receiver (2). The selective surface exchanges radiant energy with at least one emissive object (7), whereby net heat energy is transferred through radiant energy exchanged between the emissive object and the selective surface.

### CROSS-REFERENCE TO RELATED APPLICATIONS

This application claims the benefit of RPA Ser. No. 16/554,322 filed 2019 Aug. 28 by the present inventor, and PPA Ser. No. 62/921,413 filed 2019 Jun. 13 by the present inventor, which are incorporated by reference

### BACKGROUND

### Field of Invention

The disclosed embodiments relate generally to utilizing radiant energy for thermal energy transfer.

### Description of Prior Art

Transferring thermal energy is currently done in many applications with heat pumps, or other common devices that require energy input. Heat pumps, for example, are commonly used for heating and cooling buildings and other structures. Heat pumps transfer heat energy from one heat source to another.

However, heat can be transferred through radiant energy and differences in radiant absorption and emission rates. One such method is with selective surfaces. Existing selective surfaces have been used in solar collectors and comprise a surface that absorbs more than the surface emits. Specifically, the selective surfaces used in solar collectors utilize a material that efficiently absorbs radiant energy in the visible light spectrum (sunlight), but emits very little radiant energy in the infrared spectrum. These selective surfaces efficiently collect radiant energy from the sun, while emitting much less energy and, thus, heat up and keep much of the collected heat.

There also exist materials that emit infrared radiation efficiently, while absorbing very little visible light. A material that does this can cool an object, even in direct sun. To operate, the material needs to have a view of space, otherwise the material will absorb infrared radiant energy from other objects. If the total radiant energy absorbed is equal to the infrared radiant energy emitted from the selective surface material, then there is no net energy exchanged.

Both of these types of selective surfaces, one for heating and one for cooling, work through the difference between material properties for a material in the visible light spectrum versus different properties in the infrared spectrum. However, objects on earth are generally at a temperature where they emit infrared radiation generally in the range of 8 to 25 μm. Objects on Earth are generally radiating in the same spectrum, which is in the infrared spectrum.

In an aspect of this disclosure, a narrow spectral range or band will be considered a range within a recognized range, such as the infrared band, unless specifically described otherwise. However, it may also be a range that overlaps bands, such as from a part of the infrared to a part of the visible, as long as the range is not wider than the range of infrared or visible light. Ranges wider than this will be considered a wide range. Existing selective surfaces are selective between wide ranges. An example is differing absorption and emission rates in the infrared to the visible for selective surfaces for solar heat gain. Another example is differing absorption and emission rates between the infrared band and the extreme cold of the night sky for selective surfaces for cooling. An operating range for selective surfaces does not mean that they do not operate in some way outside of their designed ranges, it simply means that a majority of their function happens in or between their designed spectral ranges.

It would be desirable to have a selective surface that can heat or cool an object through emitting more or less than the material absorbs. In general, simple materials absorb the same amount that they emit. Thus, it is desirable to have a compound material comprising a plurality of simple materials to combine to make a material, called a selective surface here, that absorbs differently than it emits within its designed spectral range. It is particularly desirable and useful for, though not necessarily limited to, the selective surface and compound material being selective in the infrared spectral range.

One limitation of the existing selective surfaces is that they require visible light input (usually from the Sun), or a view of space to emit infrared radiant energy into. This limits the application to outside uses. Further, these existing selective surfaces cannot be nested—where if a first surfaces were to provide a first temperature differential (cooling or heating), then a second surface could provide a second temperature differential (cooling or heating the first surface), and so on through a set of nested surfaces. The problem with existing selective surfaces is that the next nested surface (second, third, . . . etc.) would be shielded from the sky, and thus there would only be infrared radiant heat exchanged between the surfaces. (This discussion is not considering conductive and convective heat exchange, which would not happen if a vacuum exists between the surfaces.)

Being limited to one surface, the temperature differential that can be maintained between the outside of an object with the surface and the inside of the object is limited with existing selective surfaces. For the selective surfaces that cool, the temperature difference is claimed to be about 20 degrees Fahrenheit. This is not sufficient, by itself, to cool a building in, say, 105 F degree heat to a comfortable 75 F degree inside temperature. The limited temperature difference limits the applications of these materials.

This document discloses selective surfaces that have different absorption and emission rates in a spectral range, which is generally the infrared radiant energy band. Further the selective surfaces may be nested for the use of providing and/or maintaining higher temperature differences than a single layer can provide.

For the purposes of defining the present methods and embodiments, the temperature of the selective surfaces disclosed herein are generally designed to work within 100 degrees Celsius of the temperature of another object with which it is directly exchanging radiant energy. A temperature difference within 100 degrees Celsius will be considered below a large temperature differential. This is not true of existing selective surfaces that exchange radiant energy between their selective surfaces and either the sun, or the cold of space, which are both large and high temperature differentials. Further, the selective surfaces of the present invention are generally exclusive from reflecting a significant amount of radiation energy from a third source, such as the Sun.

The embodiments and methods disclosed below can move net heat energy without external energy input. While they may be used in conjunction with common heat pumps used for the same purpose, they do not require external energy input to move net heat energy from a first source to a second source that is equal to or warmer than the first source, as do common heat pumps. External energy comprises work input, electrical power input, chemical reactions, heat of condensation or evaporation, magnetic flux, or other energy sources aside from absorbing, emitting, or radiating radiation energy.

### BRIEF DESCRIPTION OF THE DRAWINGS

For a better understanding of the embodiments of the invention, as well as additional embodiments thereof, reference should be made to the Description of Embodiments below, in conjunction with the following drawings, in which like reference numerals refer to corresponding parts throughout the figures.

FIG. 1 illustrates a cross section of a selective surface in accordance with some embodiments.

FIG. 2 illustrates a cross section of a selective surface in accordance with some embodiments.

FIG. 3 illustrates a cross section of a selective surface in accordance with some embodiments.

FIG. 4 illustrates a cross section of a selective surface in accordance with some embodiments.

FIG. 5 illustrates a selective surface in accordance with some embodiments.

FIG. 6 illustrates a selective surface in accordance with some embodiments.

FIG. 7 illustrates a selective surface in accordance with some embodiments.

FIG. 8 illustrates a selective surface in accordance with some embodiments.

FIG. 9 illustrates a selective surface comprised of an array of elements in accordance with some embodiments.

FIG. 10 illustrates a selective surface comprised of an array of elements in accordance with some embodiments.

FIG. 11 illustrates a selective surface comprised of an array of elements in accordance with some embodiments.

FIG. 12 illustrates a selective surface comprised of an array of elements in accordance with some embodiments.

FIG. 13 illustrates a top view of one or more selective surfaces inside an enclosure in accordance with some embodiments.

FIG. 14 illustrates a cross sectional view of one or more selective surfaces inside an enclosure in accordance with some embodiments.

FIG. 15 illustrates a cross sectional view of one or more selective surfaces inside an enclosure in accordance with some embodiments.

FIG. 16 illustrates a top view of one or more selective surfaces inside an enclosure in accordance with some embodiments.

FIG. 17 illustrates a perspective view of one or more selective surfaces inside an enclosure in accordance with some embodiments.

FIG. 18 illustrates a cross sectional view of one or more selective surfaces inside an enclosure in accordance with some embodiments.

FIG. 19 illustrates a cross sectional view of one or more selective surfaces inside an enclosure in accordance with some embodiments.

FIG. 20 illustrates a perspective view of one or more selective surfaces inside an enclosure in accordance with some embodiments.

FIG. 21 illustrates a cross sectional view of one or more selective surfaces inside an enclosure in accordance with some embodiments.

FIG. 22 illustrates a cross sectional view of a selective surface in accordance with some embodiments.

FIG. 23 illustrates a cross sectional view of a plurality of selective surfaces in accordance with some embodiments.

### REFERENCE NUMERALS IN DRAWINGS

1 Selective Surface

2 High Emissive Surface/Receiver

3 Highly Reflective and/or Low Emissive Surface

4 Conductive Material

5 Lens/Concentrator

6 Emissive Surface

7 Emissive Object

8 Rays of Radiant Energy

9 Aperture

10 Gap

11 Second Selective Surface

12 High Emissive Surface/Receiver

13 Highly Reflective Surface

14 Second Conductive Material/Layer

15 Second Lens (Array)

16 Second Emissive Surface

17 Second Emissive Object

18 Second Gap

19 Enclosure

20 Enclosure First Surface

21 Enclosure Second Surface

22 End Cap

23 Top Surface

28 Ray of Radiant Energy

30 Flow

Q(0) Heat Energy Out

Q(1) Heat Energy In

### DETAILED DESCRIPTION OF THE EMBODIMENTS

Reference will now be made in detail to embodiments and/or methods, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known and/or common processes, mechanisms, procedures, components, and networks have not been described in detail so as not to unnecessarily obscure aspects of the embodiments.

It will also be understood that, although the terms first, second, etc. may be used herein to describe various elements, these elements should not be limited by these terms. These terms may only be used to distinguish one element from another. For example, a first surface could be termed a second surface, and, similarly, a second surface could be termed a first surface, without departing from the scope of the present invention.

The terminology, used in the description of the invention herein, is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or”, as used herein, refers to and encompasses any and all possible combinations of one or more of the associated listed items. It will be further understood that the terms “comprises” and/or “comprising,” when used in this specification, specify the presence of stated features, steps, methods, operations, elements, and/or components, but do not preclude the presence or addition of one or more other features, steps, methods, operations, elements, and/or components thereof.

Embodiments of a thermal energy transfer system and/or device, and associated processes for using such devices are described. In some embodiments, the invention is for the use of cooling one or more objects, such as a building or refrigerator. In some embodiments, the invention is for the use heating and/or warming one or more objects, such as a building or heating a fluid. In some embodiments the invention does both depending on need and/or season of the year. In other embodiment It should be understood, however, that some of the embodiments may be applied to other devices.

In the examples about to be disclosed, the embodiments are for the general use of transferring heat energy, such as heating or cooling for example. In an aspect of the invention, the embodiments comprise one or more selective surfaces. A selective surface may be comprised of a plurality of materials, which themselves comprise surfaces. For the purpose of clarity and to define the invention, the term selective surface will comprise a surface that emits radiation energy more or less that it absorbs. The selective surface generally does not emit the same amount of radiation energy as it absorbs.

In an aspect of the invention, the selective surfaces comprise at least two different materials. In an aspect of some embodiments of the invention, the materials may be the same material but comprise different surface textures, coatings, shapes, or finishes that modify its radiant emittance and/or absorptance. For example, steel or aluminum can be polished, anodized, brushed, or oxidized with greatly modified radiant properties. For another example, a metal sheet can be painted. A metal sheet that is polished will exhibit high reflectivity and low emissivity and low absorption. While that same sheet covered with black paint will have low reflectivity and high emissivity and absorption.

In an aspect of the invention, surfaces that have consistent radiant properties that make up a selective surface may be called sub-surfaces to avoid confusion and distinctly define the invention. In an aspect of the invention, materials that are substantially transparent to radiant energy in the one or more spectral bands that the selective surfaces are designed to work in will be referred to by the common term “lens”, or “concentrator”. Common lenses are generally for focusing light or imaging. In this disclosure, the lenses are generally for the use of concentrating radiant energy, and not necessarily for imaging. Transparent materials for the use of concentrating radiant energy may also be referred to as concentrators or collectors. For the purposes of defining the invention, transparent materials are any material that are at least 50% transparent for the designed spectral range in which radiant energy is transferred.

In an aspect, the selective surfaces of this disclosure are generally designed to transfer radiant energy within a spectral range. For example, objects at common room temperature will emit radiation concentrated mostly in the 8 to 25 μm band, which comprises a spectral range. The designed spectral range may overlap between bands, such as between the infrared and visible bands.

The following embodiments and methods comprise a thermal energy transfer device or system. These devices or systems also comprise a heat pump system. However, common heat pump devices and systems generally require external work or other external energy input to move heat energy. The following embodiments and methods do not require external work or other external energy input to move heat energy.

In an aspect, the methods and embodiments of the invention transfer heat energy though radiation. Surfaces of materials emit and absorb radiant energy. So, heat energy is transferred between materials, or surfaces of the materials, through radiant energy exchange. However, the methods and embodiments are for the use of moving net heat energy. The term “net” heat energy means that more heat energy is being transferred from a first object to a second object than is being received from the second object to the first. These objects are sometimes referred to as heat sources, as is common.

Attention is now directed towards embodiments of the device.

FIG. 1 illustrates a selective surface 1 comprising a plurality of materials and/or sub-surfaces. The selective surface comprises a highly emissive material 2, a low emissive material 3, and a lens 5 made of a generally transparent material. The lens comprises an aperture 9 through which rays of radiant energy 8 pass between the lens and a gap 10. In this figure, the lens comprises a shape that has a flat and planar aperture, shown as a line on the upper side of the shape. The lens also comprises curved sides, that in this example are parabolic curves. The sides of the lens may also comprise reflective material. The use of the lens is to concentrate radiant energy, and the lens is also sometimes referred herein with the term “concentrator”.

The bottom of the lens is in contact with a receiver 2. The receiver can also be referred to as an absorber, as its purpose is to absorb radiant energy. It is beneficial for the receiver to have a surface comprising a highly absorbent material. In an aspect of the invention, the surface of the receiver may be comprised of the same material as the receiver and/or the conductive material 4 below it. Or the receiver may have an emissive surface of a different material or materials. In this example, the bottom of the lens is flat and is shown with a straight line, although it is not limited to being straight/planer. It is preferable that there is no gap between the lens and the highly emissive surface 2. The highly emissive surface comprises the receiver for the lens/CPC concentrator and the lens is in contact with the highly emissive surface. In an aspect, the aperture is also not limited to being flat/planer.

FIG. 1 also illustrates a second object which is termed the emissive object 4. The emissive object comprises at least one surface, termed the emissive surface 6, with which the selective surface 1 is exchanging radiant energy. All objects and surfaces are emissive to some degree and so the surface of the second object will be referred to as the emissive surface 6. The emissive surface is shown above the selective surface in the drawing and there is a gap 10 between the two surfaces. The gap comprises either a vacuum, or partial vacuum, or an insulative and transparent material that is mostly transparent in the working radiant bands or spectral range.

In an aspect of the invention, the emissive surface may be comprised of the same material as the emissive object. Or the emissive object may have an emissive surface of a different material or materials. For example, the emissive object may be a material, such as aluminum, that may have a surface treatment to make it more emissive. It is preferable that the emissive surface is highly emissive, as it will emit more radiant energy toward the selective surface than a less emissive material. In an aspect, any surface, including the top surface of the emissive object in FIG. 1, and other drawings, may have properties different from the material of the object.

FIGS. 1-4 illustrate some rays of radiant energy, also commonly referred to as vectors. FIGS. 1-3 show rays that are emitted from the second emissive surface 6 at a variety of angles. FIG. 1 shows rays emitted from the emissive surface of the second object at a direction perpendicular from its surface. As the viewer can see, the rays enter the lens/concentrator and then strike the receiver. In the drawing, the rays to the outside are reflected within the lens to strike the receiver. These rays may be reflected by total internal reflection if they strike the edge of the lens at an angle below the critical angle, or they may be reflected by a reflective surface on or outside of the edge of the lens.

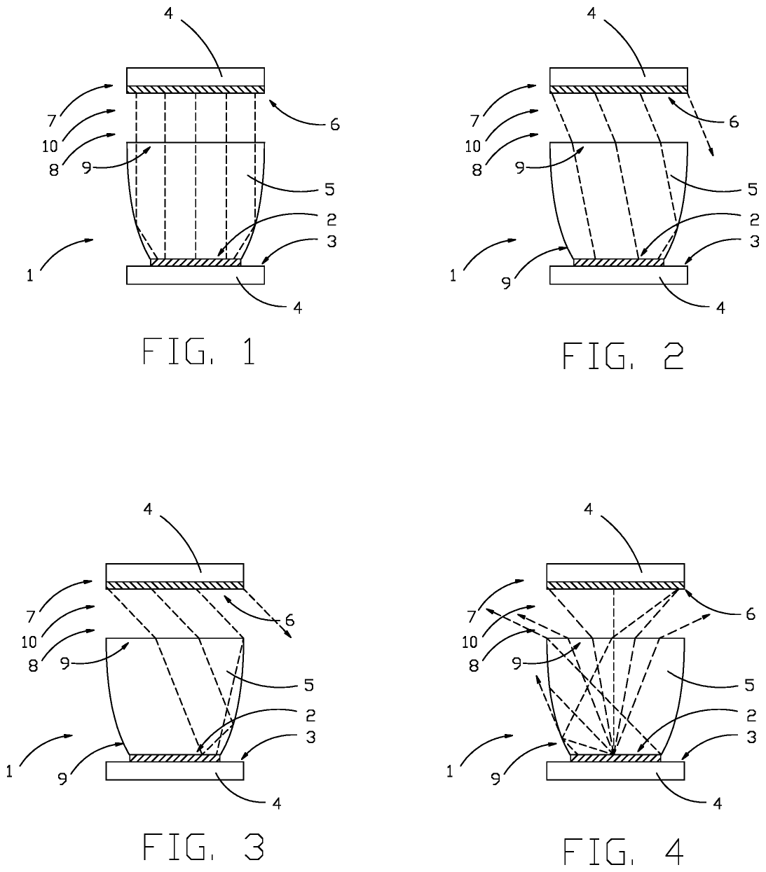

FIGS. 2 and 3 show rays at higher angles. In an aspect, it appears in these drawings that many vectors miss striking the lens and entering the concentrator through the aperture. However, if the gap is a differential of distance away from the aperture, then only a differential of angles leaving or entering the aperture can miss the emissive surface. A large gap is shown only for clarity. Further, one lens/concentrator is shown for simplicity to illustrate the concept. While the selective surface may comprise one or more lenses, it is preferable to have an array of lenses in which case a vector that misses one lens enters into another. This will be discussed below.

FIG. 4 illustrates rays of radiant energy that are emitted from the highly emissive surface 2 of the receiver. The receiver comprises the emissive surface. Some of these rays make their way out of the lens/concentrator and strike the second object. Provided the lens does not have a reflective surface at its sides, some rays may exit the lens from the sides. Provided there is an array of these lenses, rays of radiant energy may enter other lenses from the sides, and some of these rays may internally reflect off the aperture of the lens and return to the selective surface. This is to the benefit of the selective surface as some of these rays may be reabsorbed to some degree, which lowers the emissivity of the selective surface. Further, some rays emitted from the highly reflective surface of the selective surface may also be reabsorbed to the same benefit.

FIG. 22 illustrates an array of three lenses, and also illustrates highly reflective surfaces 3 and 13 that reflect rays of radiant energy 8 to the receiver 2. Reflective surface 3 is in contact with the side of a lens. The reflective surface may be part of the conductive material 4, or part of the lens 3. Its purpose is to reflect rays of radiant energy to the receiver. Rays of radiant energy that have entered an aperture of a lens 9 could exit the lens without striking the receiver if they strike the side of a lens at an angle greater than the critical angle. For many lens materials, this is only possible in the lower part of the lens. Thus, the reflective material does not need to completely cover the side of a lens, although it may. The reflective surfaces to the outside of the lenses in this figure show an embodiment in which the reflective surface 3 is in contact with, or comprises the outside surface of a lens.

In an aspect, the conductive materials and the emissive objects in these figures may be considered heat sources, as heat energy is transferred to or from them. These objects are generally in contact or exposed to an outside environment, which can also be considered as heat sources. Examples, of outside environments are, but not limited to, housings, enclosures, outside air, water, or other materials.

In an aspect, it is generally preferable for there to be no gap between the receivers and the concentrators in many of the embodiments of this disclosure that have a straight or planer receivers, as seen in these figures. This is due to possibility or rays of radiant energy internally reflecting off of the flat/planer side of the lens/concentrator and not reaching the receiver. However, and in an embodiment, the receiver may have a “V” shape, or conical shape whereby any internal reflection off of one side of the “V” or cone would then exit the other side. With this shape, a gap may be present without adversely affecting performance.

In an aspect, rays of radiant energy may be partially absorbed by reflecting off of a reflective surface. Whereas rays traveling though a transparent medium, such as the concentrator/lens here, which are below the critical angle would reflect by total internal reflection if there is no reflective material in contact with the sides of the lens. It thus may be desirable to have a gap between the reflective material and the side of the lens. By this method and embodiment, rays below the critical angle will totally internally reflect, and rays above the critical angle will exit the lens, and then be reflected back into the lens by a reflective surface 13 at a gap from the lens, as seen in FIG. 22 in the middle lens.

In a method of transferring net heat energy radiantly to a first heat source 1 from a second heat source 7, wherein the first heat source is at the same or higher temperature than the second heat source; the method comprising:
a. Concentrating radiant energy 8 from one or more emissive objects 7 to at least one receiver 2;
b. Absorbing radiant energy at the one or more receivers;
c. Emitting radiant energy from the one or more receivers;
   wherein the receiver(s) emit less radiative energy than is absorbed from the emissive object(s) for a range of conditions where the temperature of the receiver is not below the temperature of the emissive object(s) with which the receiver exchanges radiant energy. In an embodiment that utilizes this method, a lens/concentrator 5 concentrates the radiant energy that flows into the lens through the aperture of the lens 9 to the one or more receivers 2. (FIGS. 1-4)

### MATERIALS

A preferable material for the lens/concentrator is Potassium Bromide (KBr) for selective surfaces of the present disclosure that operate in the infrared region. Potassium bromide has exceptional transmissibility in the infrared region. It has a refractive index of approximately 1.55. (Due to dispersion, the refractive index varies with wavelength.) Using Snell's Law, the critical angle of infrared radiant energy entering or leaving potassium bromide from an insulative material, such as air, other transparent gases, and/or a partial vacuum, works out to be approximately 42 degrees from a line extend perpendicular to the surface of the lens.

A list of alternative materials for the lens/concentrator comprises: Calcium Fluoride (CaF2), Fused Silica (FS), Germanium (Ge), Magnesium Fluoride (MgF2), N-BK7, Sapphire, Silicon (Si), Sodium Chloride (NaCl), Zinc Selenide (ZnSe), Zinc Sulfide (ZnS), or any material suitably transparent in the design spectral range. The index of refraction for these materials is generally between 1.4 and 4. Other material may also suffice, for example, semiconductors are generally transparent to infrared wavelengths and they may be utilized.

Real world materials do not exhibit perfect absorption, emittance, or reflectance. However, materials exist that exhibit very high or low values for these properties. Aluminum, for example, can have an emissivity of 0.04 if highly polished, or 0.77 if anodized. If covered with Parson's black paint, the emissivity may be 0.95. Note: these example numbers are fractions of a blackbody's ideal properties and are not listed to limit the invention.

### COMPOUND PARABOLIC CONCENTRATORS

Compound parabolic concentrators are known devices. (They are sometimes also referred to as “compound parabolic collectors”, or “lens” here.) For this disclosure, they will often be referred to as CPCs, or CPC in the singular. CPCs are non-imaging radiant concentrators that have found common use in solar collectors. CPCs for solar use have reflective inner surfaces and concentrate solar radiant energy to a receiver. These concentrators take advantage of the directional distribution of sunlight, which is mostly in the direction of the sun. Diffuse sunlight generally comprises much less than half of the radiant energy from the sun on a clear day. The majority of radiant energy from the sun comes in one direction. However, when it is cloudy diffuse sunlight reaching the surface of the Earth may comprise a much higher percentage.

The concentration factor for CPC's is given by the formula C=1/sin Ø, where angle Ø represents the acceptance half-angle. So, if an acceptance half-angle of 42 degrees is chosen, then C=1.49. This means that for radiant energy that enters within the acceptance angle range, the receiver is receiving about 50% more radiant energy than it would otherwise receive without the CPC. This is the ideal case assuming perfect reflectance. With real world materials, some radiant energy is absorbed by the reflective material inside the CPC, if present, and the concentration factor would be reduced.

In an embodiment, a CPC is filled with a transparent material, or solely comprises a transparent material. In an embodiment, the index of refraction of the transparent material is substantially different from an insulating material, or vacuum, or partial vacuum through which radiant energy comes towards the CPC—providing an index of refraction generally of 1.2 or higher. (For the purposes of defining the invention, a substantially different index of refraction will be defined as greater than 10%.) Provided Potassium bromide is the transparent material (generally transparent for infrared light), infrared radiant energy vectors within the CPC will be refracted upon being transmitted into the transmissible material of the concentrator and will not exceed 42 degrees from a vector perpendicular to the top surface of the transparent material that fills the CPC and pointing towards the receiver of the CPC.

FIG. 1 illustrates a two-dimensional cross-section of an embodiment comprising a CPC filled with, or comprising transparent material. For this two-dimensional example, radiant energy may enter through the aperture 9 of the CPC. Provided the sides of the CPC comprise reflective material on the inside, all the radiant energy that enters the CPC will strike the receiver at the bottom, provided this CPC has an acceptance half-angle greater than the critical angle. (Note: this assumes perfect reflection within the CPC.) For example, and in an embodiment, a CPC comprises a half acceptance angle of 42 degrees. For this geometry, all vectors steeper than, or at 42 degrees will make it to the receiver. This comprises all the vectors (that are not reflected off the top surface of the transmissible material or absorbed in imperfect reflection) that enter the top due to the CPC being filled with a transparent material with a higher refractive index than outside of the CPC. In this ideal example and embodiment of a selective surface, which comprises the CPC and the receiver, the radiant energy from a first emissive surface of a second object will be absorbed by the receiver. The CPC will concentrate the radiant energy approximately by a factor of 1.5 (in one dimension).

The receiver's length, by contrast, is one divided by the concentration factor C (inverse of C). So, the receiver comprises approximately only 0.67, or two thirds of the length of the top opening and aperture of the CPC in the example shown in FIG. 1. Provided the receiver 2 and the emissive surface 6 of the second object are at the same temperature, and the receiver and emissive surface of the second object are made of the same material, the receiver will emit approximately ⅔ less radiant energy than it is absorbing from the emissive surface 6. (This is assuming the receiver and emissive surface are at approximately the same temperature.)

To consider the complete system, and take into account likely real-world materials, let's assume that the reflective surface 3 reflects 90%, and the receiver 2 and first surface 6 absorb 90%. The first surface here is the emissive surface 6 of the emissive object 4. In this case, the receiver absorbs 90% of the first surface radiation energy. (Note that any energy absorbed in a reflected vector in the CPC lowers the amount of energy absorbed by the receiver of the CPC, but it is still absorbed by the selective surface.) Assuming the area of the first surface is 1 unit, and also the area of the receiver is ⅔ of that 1 unit, then the selective surface is absorbing 50% more radiant energy than it is emitting (1 divided by ⅔, expressed as a percentage increase) minus the radiant energy that the reflective surface is emitting. Considering that the reflective surface 3 emits 10% (100%−the 90% reflectance), the surface is selective if the length of the reflective surface is less than approximately 3.3 times the length of the top surface, which would yield 0.33 (3.3×0.1), if it equaled 3.3. (In this simplified 2D example, area is equivalent to distance.) This is certainly the case, and so the surface is selective.

In an aspect of the invention, infrared or other radiation from a surface coming toward a selective surface comes from many directions. If a Blackbody is assumed, the directional distribution is even and radiant energy comes from every direction by the same amount. However, this is a bad assumption to make, as real materials generally radiate much less in directions at high angles to a vector perpendicular to the radiating surface. The distribution is not uniform for real world materials. This real-world property is to the benefit of the present invention, as very few radiant vectors either exit the lens/CPC, or need to be reflected to the receiver through a reflective surface.

In the embodiment above, the acceptance half-angle is greater than the critical angle. The critical angle is the angle at which a vector parallel to the top surface of the CPC would enter into the CPC due to the refraction the transmissible material provides. In an aspect of the invention, real world materials do not have the directional distribution of black bodies. In general, real world materials emit much less radiant energy at high angles to a vector perpendicular to and outward from the emitting surface than they emit at small angles. For this reason, it may be beneficial to design a CPC with a smaller acceptance half-angle and higher concentration factor. In an embodiment, the acceptance half-angle is smaller than the critical angle. In this embodiment, not all radiant energy vectors will reach the receiver. However, the gain in concentration factor may outweigh the loss in lost vectors, particularly if the material radiating energy at the CPC radiates less radiant energy at the angles that do not reach the receiver than at angles that do reach the receiver.

In an aspect of some embodiments of the invention, it is known that reducing the height of a CPC will reduce its concentration factor. But, reducing the height may only reduce the concentration factor by a small amount, depending on the amount. The reason is that the upper sides of a CPC, which are parabolas, are very steep at the top, and contribute little to the concentration. In an embodiment, the CPC comprises a reduced height parabola.

In an aspect of the invention, other shapes may be used. While some embodiments may be limited to CPCs, other embodiments may comprise non-parabolic shapes. For example, and in an embodiment, a concentrating collector may comprise sides with straight lines in cross section, or simple curves or arcs. In an aspect of the invention, CPCs comprises the concentrating collector(s), len(s), or concentrator(s) of the invention.

In an aspect, the concentration ratio and particular dimensions and specifications listed in the above example represent an embodiment, however they were not given to limit the invention to that one embodiment and those specific dimensions and specifications. The above example was chosen to illustrate and disclose both the embodiment and the general theory of operation of the invention.

### THREE DIMENSIONS AND ARRAYS

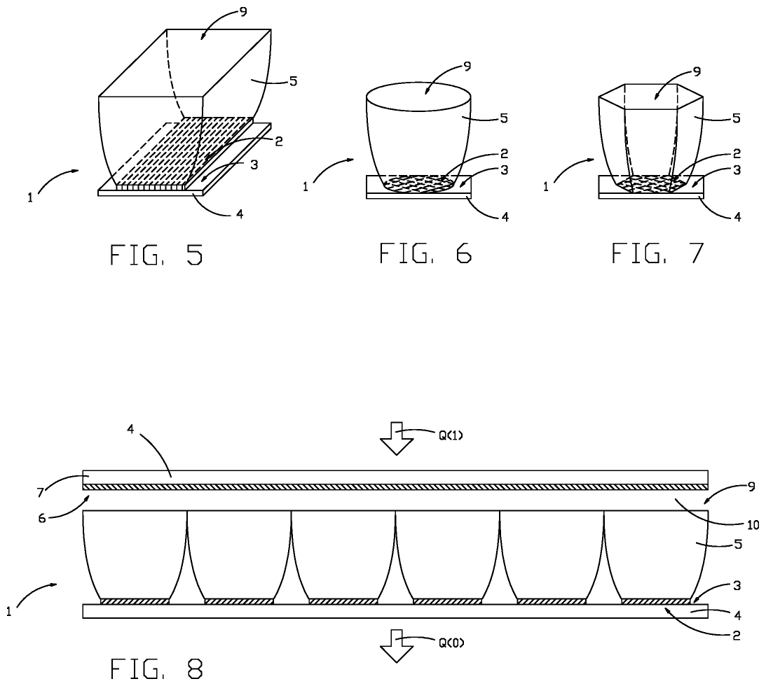

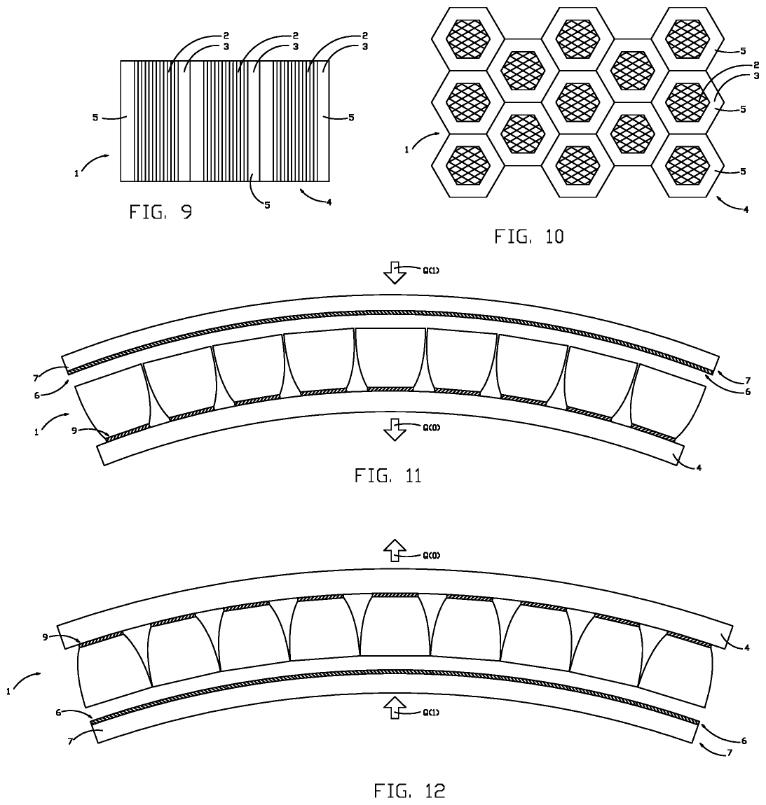

In an aspect of the invention, the two-dimensional cross-sectional shapes shown FIGS. 1-4 may be turned into a variety of three-dimensional shapes. For example, and in an embodiment, the two-dimensional shape of FIG. 1 may be extruded linearly to form a trough, as illustrated in FIG. 5. Likewise, an array of the two-dimensional shape of FIG. 1 may be extruded linearly to form an array of troughs, as illustrated in FIG. 9 (top view), and FIG. 8 (cross-sectional view).

Further, and in an embodiment, a two-dimensional shape may be revolved into a three-dimensional shape, as illustrated in FIG. 6. In this case, the concentrator resembles a cup, with the shape of the aperture 9 of the lens being a circle. Further, the selective surface may comprise an array of these shapes. In an aspect, an array of lenses with circular apertures may not be closest packed, as circles cannot be placed edge to edge without gaps.

In an aspect of the invention, three-dimensional shapes often have higher concentration ratios. For example, the revolved three-dimensional shape illustrated in FIG. 3 comprises a higher concentration ratio for a given acceptance half-angle. For example, if an acceptance half-angle of 45 degrees is selected, then the above listed formula for a two-dimensional CPC yields a concentration ratio of 1.414. This means that the receiver's length is 1/C or 0.707 of the length of the aperture of the CPC. The formula of the area of the circular receiver of FIG. 3 is given by the common formula πr². The concentration ratio of the 3-D shape is given by the area of the aperture divided by the area of the receiver, so C=π²/π(0.707*r)², as the ratio between diameter and radius is the same. Values cancel, and C works out to a concentration value of 2, with a receiver area that is just half of the area of the aperture. Thus, a three-dimensional revolved shape has the higher concentration value of 2 versus 1.414 for the two-dimensional example, or for a linear and/or extruded trough.

In an aspect of the invention, it is useful to turn a two-dimensional shape into a three-dimensional shape with an area that is a shape that can be closest packed together into an array or grid of concentrators. Closest packed shapes comprise triangles, squares, rectangles, trapezoids, and hexagons, etc. In an embodiment, the selective surface comprises an array, or hex grid of concentrators, as illustrated in FIG. 8 (cross-sectional view) or FIG. 10 (top view).

There exists two ways to closest pack these shapes. One method, and in an embodiment, the cross-sectional shape from edge to edge is the shape of the two-dimensional shape of FIGS. 1-4.

A second method is where three-dimensional shapes may overlap. In an example and embodiment, revolved circular shapes may overlap to closest pack.

FIGS. 9 and 10 show a top view of a selective surface comprised of arrays of lenses, and receivers. These may be placed on and/or in contact with one or more conductive surfaces. The view is looking down on the apertures of the lenses. An array of lenses and receivers may be any array, such as a linear array FIG. 9, or a two-dimensional array FIG. 10. Preferably, the array is an array of lenses with aperture shapes that closest pack, such as triangles, rectangles, squares, or hexagons, but may be any shape.

FIG. 9 shows a one-dimensional array of the selective surface shown in FIG. 5, which is an extruded trough. This figure shows an array with three lenses. But, of course, this array could be any number. Further, placing two linear arrays side by side would yield a two-dimensional array.

FIG. 10 shows a two-dimensional array of the selective surface shown in FIG. 7. Because this array is not comprised of apertures with like-sized rectangles, the array is not simple rows and columns, but is an array suitable for these hexagonal elements. A person skilled in the art can choose from different arrangements of placing the lens elements and suggested lens elements of this disclosure into some arrangement of array or packing that comprises a surface full of a plurality of lenses/concentrators and receivers without departing from the scope of the invention.

An array, or other plurality or singularity of generally transmissible lenses contact a generally conductive surface on which they are in thermal contact. This surface is not limited to a planar surface. FIGS. 11 and 12 illustrate a selective surface comprising an array of lenses placed on a curved surface. FIGS. 18 and 19 illustrate the same arrays as FIGS. 11 and 12, but the curve is continuous and they form a circle.

In an aspect, real world objects generally do not exist in vacuums. Provided the objects illustrated in FIGS. 11 and 12 are surrounded by an environment, such as air, the outside edges and/or surfaces of these objects will be in contact with that environment and will exchange heat energy with that environment.

FIGS. 18 and 19 (and 14, 16, and 21) also illustrate a series of selective surfaces and emissive objects. These figures represent linear arrays, as viewed from the side (or cross-section). But these figures also represent cross sections of three-dimensional objects, wherein each object extends significantly in the Z-direction. (The Z-direction is out from the page.) The lenses of these selective surfaces may then comprise two-dimensional arrays, or linear troughs.

These figures also illustrate embodiments comprising at least one selective surface that facilitates transferring heat energy from an outside environment to or from the inside environment. The embodiments of FIGS. 18 and 19 both comprise a tube. In the particular embodiment illustrated in FIG. 18, net heat energy will transfer radiantly to the inside material of the tube provided the outside temperature of the tube is above the equilibrium outside temperature. The outside equilibrium temperature is defined here as a temperature that is at a temperature differential to the inside temperature for the conditions where there is no net heat transfer between the inside and outside. The outside equilibrium temperature depends on the inside temperature and is at a differential of temperature to the inside temperature. It is not the same temperature. Likewise, an inside equilibrium temperature is defined here as a temperature that is at a temperature differential to the outside temperature for the conditions where there is no net heat transfer between the inside and outside.

In an aspect of the invention, the embodiments and methods of the present invention comprising selective surfaces will transfer net radiant heat energy in a direction from one side to another when the two sides are at the same temperature, or below a temperature differential. If one side warms up, and/or one side cools due to the net heat transfer, net heat transfer will occur until the conditions are met where the heat transfer rate in opposing directions are equal. This may occur when the warmer side is warm enough to emit more radiation, as a warmer body will emit more radiation energy per unit area of radiating material. It may also occur in embodiments where there is a path for heat to conduct or convect in the opposite direction of the net radiant heat energy transfer. In this case, the equilibrium temperature differential is reached when the net radiant energy transfer in the direction of the selective surface from or to another object equals the conduction or convection in the opposite direction. In an aspect, heat can also be transferred though condensation, evaporation, or other common means, and an equilibrium of heat energy transfer may also occur due to these processes.

In an aspect of the invention, the cross section of these embodiments does not need to be limited to circular cross sections. Other shapes may apply. Also, any number of selective surfaces in series may be used. Two has simply been shown to not unnecessarily complicate the description.

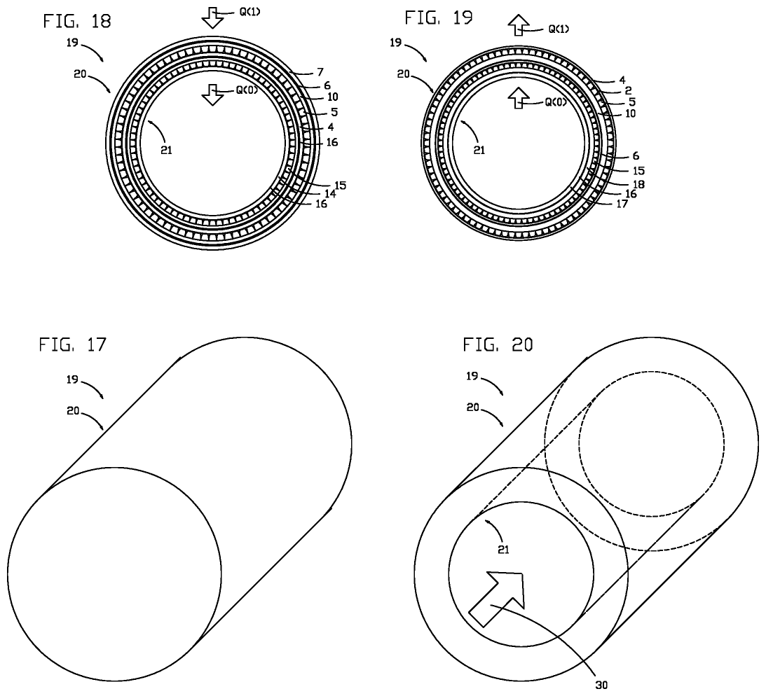

In an embodiment, FIG. 17 illustrates a tube with closed ends. The tube comprises one or more selective surfaces. FIGS. 18 and 19 illustrate cross-sectional views of examples and embodiments wherein there is one or more selective surfaces between the inside of the tube, which in these figures is the second enclosure surface 21, and the outside, which is the first enclosure surface 20.

In FIG. 18, the selective surface(s) are arranged such that heat energy will flow into the tube, provided the temperature difference of the inside and outside of the tube is within the equilibrium temperature differential, or the temperature outside is greater than the inside temperature. Q(1) represents heat energy that conducts or otherwise enters into the outside conductive material of the tube. Q(0) represents the heat energy transferred into the tube, which may contain a material.

In FIG. 19, heat energy will flow in the opposite direction, as the selective surfaces and emissive objects are positioned in the opposite direction with regard to the center of the tube. Q(0) represents heat energy that flows from the inside material to the conductive elements and selective surface(s). Q(1) represents heat energy that flows out of the tube to the outside environment. In the particular embodiment illustrated in FIG. 19, net heat energy will transfer to the outside material of the tube provided the inside temperature of the tube is above the inside equilibrium temperature.

In an aspect, it is beneficial to have the gaps 10 between the one or more selective surfaces and the one or more emissive objects and surfaces be at an at least partial vacuum to lessen conduction in the opposite direction of the net radiation exchange between the objects. In this case, a tube with a circular cross section is a preferable shape to handle compressive loads on the outer and/or inner walls of the tube caused by the pressure differential of the at least partial vacuum. A tube has an advantage that it does not require columns to support compressive loads along its Z-axis length, although they may be used. Support for the compression loads that a differential of pressure between the outside of the tube, and the one or more gaps, and/or the inside of the tubes can be handled at the end of the tube at one or more end caps.

FIG. 17. Illustrates a perspective view of an enclosure which in this example and embodiment is a tube. In this case, the tube has closed ends or end caps 22, which may be part of the tube or a separate part. A tube with closed ends could be used to keep some contents within the center of the tube either colder or warmer than the outside environment through the net radiant heat transfer from or to the inside to or from the outside. Any common method of attaching a cap, such as through threads, may be used. An example would be an end cap that screws on.

In an aspect, the end caps may comprise selective surfaces of the present invention, or may not. Provided the end caps do not comprise at least one selective surface, the end cap may be made of an insulative material to limit the conduct heat transfer that may be in the opposite direction of the desired radiant heat transfer that the selective surfaces provide. The direction is in respect in the in and out of the enclosure.

FIG. 20 illustrates a tube which comprises a pipe. A material may be moved through the pipe to cool or warm the material. Example materials comprise a fluid, such as air, water, or any other fluid. The material is not limited to fluids, the material may comprise solids or composite materials. Arrow 30 simply represents a flow of material through the pipe.

In an aspect, these pipes and tubes are not limited to being straight. Further, they are not limited to a circular cross section.

Further, and in an embodiment and method, selective surfaces may be layered and used in series that comprise generally flat plates stacked up, or other shapes. FIG. 23 illustrates two selective surfaces and emissive objects in series with a first layer on top of a second layer. In this figure, the second emissive object 17 is the same element as the conductive material 4. The second emissive surface is the bottom surface of this element. In an aspect of the invention, an emissive object may be a separate element, or the same element as the conductive material of a selective surface 1. As can be seen in this illustration, the second emissive surface exchanges radiant energy with the second selective surface 11. By this method any number of one or more selective surfaces may be layered.

In an aspect, when selective surfaces are used in a series or layers, the equilibrium temperatures between an environment on one side of the series and the environments on the other side of the series will increase with each added layer. The total heat rate transferred through the levels, however, may be limited to lowest common denominator. More levels do not necessarily move more total heat energy per unit of time. An advantage lies in maintaining a higher temperature differential between the two heat sources, and the total heat energy transferred may be increased in certain embodiments and/or conditions.

In an aspect, if the outside environment is an ambient environment, representing a heat source of constant temperature, and the inside environment is a limited amount of material at a starting temperature, radiant heat energy will be transferred between the inside and outside environments until a temperature differential is reached wherein the amount of radiant heat being transferred in equals the heat transferred out. Considering that one or more selective surfaces within an enclosure generally need to be supported, and that there is generally at least one conduction path, the conduction often transfers heat energy in the opposite direction of the radiant heat energy transfer in the present embodiments and methods of the invention. Thus, it is preferable to minimize any conduction paths.

FIG. 23 illustrates a top surface 23. The top surface is the interface between the selective surface(s) of these embodiments and an outside environment. The top surface is the surface that transfers heat energy between the selective surface(s) below and the outside environment, which in these drawings is the environment above the top surface. In an aspect, the outside environment could be in any direction. The top surface transfers heat energy though conduction, convection, and/or radiation, or any other common means.

In an aspect, the top surface may be exposed to the sky. In embodiments, the top surface may be a common selective surface that is selective between visible light and infrared. For example, and in an embodiment, the top surface 23 may be highly absorbent to visible light from the sun, and less absorbent and emissive in the infrared spectrum to best transfer heat into the selective surface(s) illustrated in FIG. 23. In a second example and embodiment, the top surface may be highly reflective to visible light from the sun, and more emissive in the infrared to best transfer heat out from the selective surface(s) illustrated in FIG. 23. However, this second embodiment would be useful for the selective surfaces oriented in the opposite direction as shown in FIG. 23. These conventional selective surfaces can be applied to the outer surfaces of many of the embodiments of this disclosure. In an aspect, the top surface may also comprise a surface that is of high or low absorption, emittance, or reflectivity that is not a selective surface, or another surface.

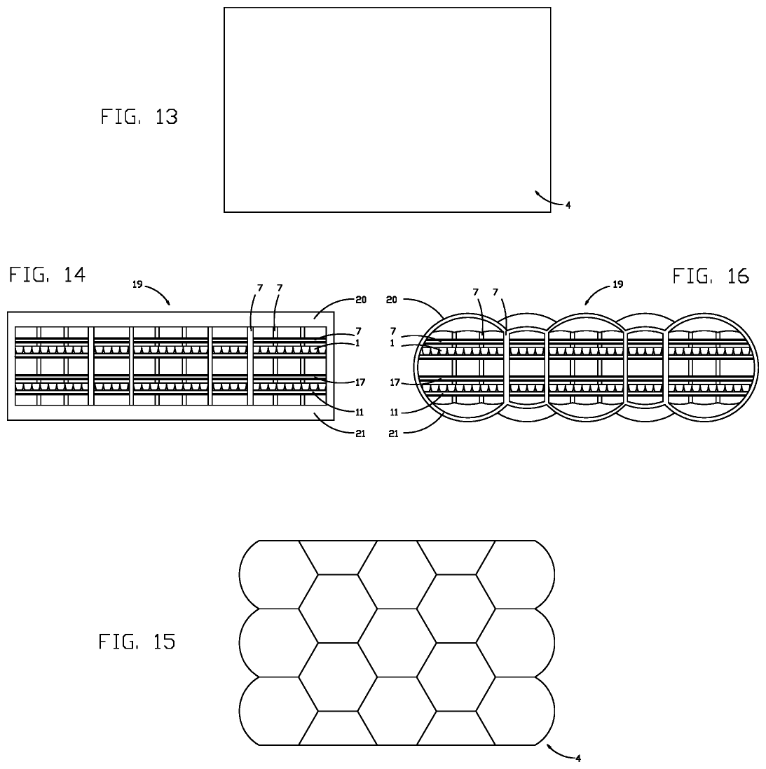

FIGS. 13-16, and 21 show different views of an enclosure that may be referred to as a panel, or sheet. These enclosures comprise first and second surfaces through which the enclosure transfers heat energy with one or more environments. The enclosure encloses one or more selective surfaces 1, 11 and one or more emissive objects 7, 17. These figures show two layers, but there can be one or more layers. Each layer comprises at least one selective surface. Each selective surface of each layer may comprise an array of lenses and receivers.

FIG. 13 illustrates a top view of a panel that comprises one or more selective surfaces. This figure illustrates a rectangular shape, but the panel could be another shape and is not limited to a rectangle. FIG. 14 illustrates a cross section taken from the center of the panel. This panel can also be referred to as an enclosure, as enclosed within are one or more layers of selective surfaces 1, 11, and emissive surfaces 6, 16, of the emissive objects 7, 17, and other elements of the invention herein disclosed. In an aspect, the panels, sheets, and enclosures of this disclosure can be used to make other enclosures. For example, a box could be made using these panels. Further, any insulation panel could be replaced with these panels. These panels can be considered insulation panels or sheets, but common insulation values would not apply.

In an aspect, it is preferable for the inside of the enclosure of a panel to have a vacuum or partial vacuum separating the layers and elements to minimize conduction in the opposite direction from the direction of desirable radian heat transfer. In an embodiment, as illustrated in FIGS. 14, 16, and 21, the spaces or gaps between elements and layers comprise a vacuum or partial vacuum. In an aspect, this may create a pressure difference between the outside environment and the inside. The pressure difference can be resisted provided the wall thickness is of sufficient thickness to not bend inward contacting the selective surfaces and other elements within. The strength to resist inward bending can be improved by including columns. In embodiments, as illustrated in FIGS. 14, 16, and 21, the panels comprise columns 7 for this use, and general structural integrity.

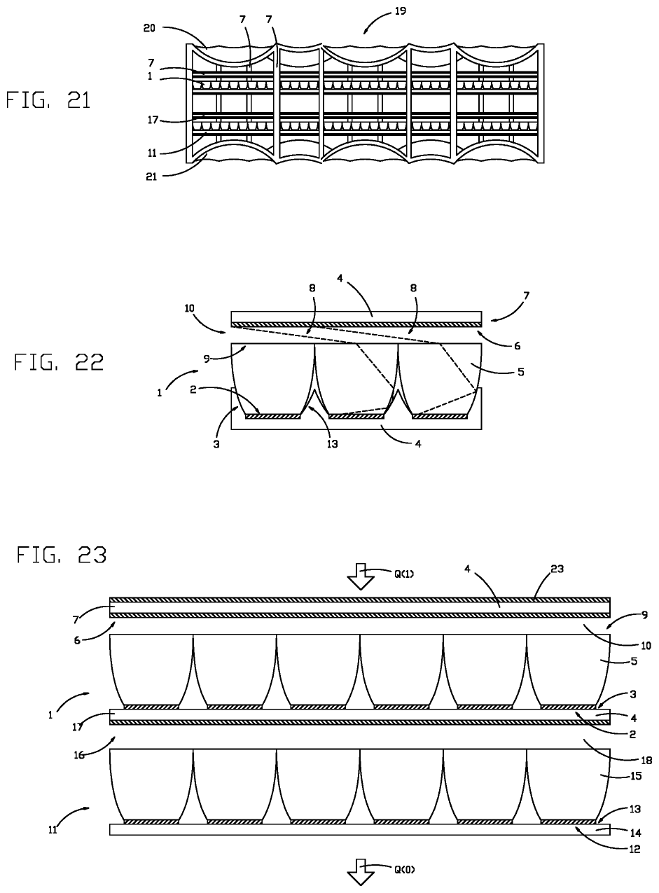

In an aspect, and similar to architecture, use of arches can minimize the number of columns needed, and/or increase the spacing of columns for a given structural strength. FIG. 16 illustrates a panel and enclosure 19 comprised of enclosure surfaces comprising arches. This embodiment is good for materials with high compressive strength, or isometric properties, such as metals. FIG. 21 illustrates a panel and enclosure 19 also comprised of enclosure surfaces comprising arches. However, in this embodiment, the arches will resist higher outside environment pressures with tensile strength. As such, this embodiment is good for materials with high tensile strength, or isometric properties, such as metals.

FIG. 15 illustrates a top view of a panel comprised of an array of arches. The arches are shown in a hexagonal array, but could be another array, such as a square or rectangular grid. FIG. 15 also illustrates two different methods of handling the edges of the panel, but the edges are not limited to these two examples. Further, insulation could be added to the edges to make any outside shape.

For the purposes of clarity in understanding the invention in the illustrations, FIGS. 14, 16, and 21 (as well as others) show the selective surfaces and emissive objects as separate elements from the enclosure surfaces. However, the enclosure surfaces may comprise the selective surface and emissive elements, similar to what is illustrated in FIG. 23. For example, the emissive object 7 in FIG. 14 may be the enclosure surface 20, or part of it. The larger (as drawn) top, center, and bottom gaps need not exist. Further, the second emissive object 17 can be the same as the conductive bottom sheet of the first selective surface 1.

### USES

The present selective surfaces and the embodiments enclosing them have a wide variety of uses, as they can move heat energy in the opposite direction of simple conduction. Obvious uses are the replacement of insulation. For example, an ice chest could comprise a box with at least one of its six sides replaced by a selective surface comprising a panel comprising one or more selective surfaces. The same is true for a refrigerator.

Other uses comprise using panels or tubes through which a fluid, or other material, is passed to cool or heat the material. That material can then be used to cool or heat another object, such as a building, industrial process, domestic process, or heat storage device such as a TES, which may then in turn transfer heat energy with a building, industrial or domestic process. A TES may comprise PCM. Likewise, these embodiments and methods may be used to transfer heat energy for purposes, such as, but not limited to, warming or cooling transportation devices, or warming or cooling swimming pools, or transferring heat to hot water heaters or preheaters.

Another use, and in an embodiment and method, one or more panels comprising selective surface(s) of the present invention may be offset from a ceiling, floor, or wall to move heat within a space, such as a room. For example, and in a method of use, if a panel comprising selective surface(s) is hung from the ceiling above a bed, the panel could be oriented to move heat energy toward the ceiling and away from a person sleeping in the bed. The heat gradient of the room could be increased with the air near the ceiling being warmer than it otherwise would be without the panel. The person sleeping in the bed could then be in a cooler temperature, even though the average temperature in the room stayed the same, as no energy would be entering or leaving the room as a whole due to the panel. This would reduce the need for A/C or other cooling methods in places where the temperature in the room would otherwise be too warm for comfortable heating. Further, the underside of the panel would be cooler than the ceiling would otherwise be without the panel, and the underside of the panel would absorb some net radiant energy further cooling the sleeping person. In an aspect, if the panel is oriented in the opposite direction, the panel could be used to provide a warmer environment to the sleeping person. In a method, one or more panels may be flipped over to switch between uses.

The present embodiments and methods are generally for the use of heating and cooling. These uses may be steps to a further use. For example, heat energy could be used to aid in evaporation of water, and cooling could be use to aid in condensing water. Both of these steps could be used for distilling water and/or desalination.

In an aspect and embodiment or method, existing common selective surfaces may comprise a top surface with the selective surfaces of the present invention comprising one or more lower layers. Existing selective surface are useful for exchanging radiant heat energy with the sun and/or sky, and the selective surfaces of the present invention can complement this functionality by increasing the overall temperature differential between two heat sources. Thus, the selective surfaces of the present invention may also be used for the same uses as existing selective surfaces. In another aspect, the top or bottom surfaces of an enclosure comprising the selective surfaces of the present invention may comprise surfaces and/or materials with high reflectivity or high absorption for the use of avoiding or adding to radiant heat gain of the outside surfaces.

These examples are, of course, some of many uses, and the invention should not be limited to these example uses.

### Summary, Ramifications, and Scope

The embodiments, methods, examples, and aspects of the embodiments and invention are disclosed herein to summarize the invention and are not intended to limit the scope of the invention.

The present disclosure generally relates to using radiant energy to transfer heat energy from a first source to a second source wherein external work input is not required. Net radiant energy may be transferred or moved in some embodiments within a spectral range of radiation.

The disclosed invention eliminates the problems associated with other methods of moving heat energy, which generally require work input, and/or external energy input. It is an object of some embodiments of the invention to transfer heat energy from a cooler first source to a relatively warmer second source wherein external work input is not required.

Further, some of the embodiments of the invention disclose methods and embodiments comprising placing the selective surfaces of the present disclosure into enclosures, such as tubes, pipes, and panels. In some embodiments, this enables the cooling or warming of a material that flows through an inner passage of the enclosure.

The disclosure of the present invention as well as any references to preferred embodiments and other embodiments, are not for limiting the scope of the invention. Persons having ordinary skill in the art may make various modifications and changes without departing from the scope and spirit of the invention. Therefore, the scope of the appended claims should not be limited to the description of the embodiments described above. Accordingly, the scope should be determined not by the embodiments illustrated, but by the claims and their legal equivalents.

1. A heat transfer device comprising at least one selective surface, wherein the selective surface comprises at least one radiant concentrator, and at least one receiver, wherein the receiver(s) comprise one or more surfaces for absorbing and emitting radiant energy; wherein the heat transfer device transfers more radiant heat energy to the receiver(s) than the receiver(s) emit in a range of conditions where a temperature of the receiver(s) are not below a second temperature of one or more emissive objects with which the receiver(s) exchange radiant energy.

2. The invention defined in claim 1, wherein at least one of the one or more radiant concentrators comprises a CPC.

3. The invention defined in claim 2, wherein the CPC is filled with a transparent material.

4. The invention defined in claim 1, wherein the one or more emissive objects do not comprise the sun.

5. The invention defined in claim 1, further comprising an array of the one or more radiant concentrators.

6. The invention defined in claim 1, further comprising a plurality of selective surfaces, wherein the plurality of selective surfaces are layered.

7. The invention defined in claim 1, wherein the heat transfer device comprises an enclosure.

8. The invention defined in claim 7, wherein the heat transfer device comprises an enclosure that moves heat energy from inside the enclosure to outside the enclosure.

9. The invention defined in claim 7, wherein the heat transfer device comprises an enclosure that moves heat energy from outside the enclosure to inside the enclosure.

10. The invention defined in claim 7, wherein the heat transfer device comprises a tube or a pipe, wherein a material flows through the tube or pipe.

11. The invention defined in claim 7, wherein the heat transfer device comprises a panel or a pane.

12. The invention defined in claim 11, wherein a material flows through the panel or pane.

13. (canceled)

14. (canceled)

15. The invention defined in claim 1, wherein the selective surface is selective within a narrow spectral range.

16. A method of transferring net heat energy radiantly to a first heat source from a second heat source through one or more selective surfaces, wherein the first heat source is at the same or higher temperature than the second heat source; the method comprising:
a. Concentrating radiant energy with at least one radiant concentrator from one or more emissive objects to at least one receiver;
b. Absorbing radiant energy at the one or more receivers;
c. Emitting radiant energy from the one or more receivers;
wherein the receiver(s) emits less radiative energy than is absorbed from the emissive object(s) for a range of conditions where the temperature of the receiver is not below the temperature of the emissive object(s) with which the receiver exchanges radiant energy.

17. The invention defined in claim 1, wherein the range of conditions comprises a temperature differential between the receiver(s) and the emissive object(s), wherein the temperature differential ranges from zero to a non-zero temperature differential that occurs when there is no net heat energy transferred between the receiver(s) and the emissive object(s).
